(19) United States
(12) Patent Application Publication
(10) Pub. No.: US 2024/0109597 A1
(43) Pub. Date: Apr. 4, 2024

(54) FRONT CROSSMEMBER ASSEMBLY FOR THE SMALL OVERLAP FRONTAL CRASH TEST

(71) Applicant: PSA AUTOMOBILES SA, Poissy (FR)

(72) Inventors: Rodolphe PERON, HERBLAY (FR); Thibault GOURVENNEC, DRAVEIL (FR)

(21) Appl. No.: 18/264,653

(22) PCT Filed: Jan. 18, 2022
(86) PCT No.: PCT/FR2022/050096

§ 371 Date: Aug. 8, 2023

(30) Foreign Application Priority Data
Feb. 18, 2021 (FR) 2101550

(51) Int. Cl. B62D 25/08; B62D 29/00; B62D 65/02

(52) U.S. Cl. CPC B62D 25/085; B62D 25/084; B62D 29/005; B62D 65/024

(57) ABSTRACT

The invention relates to a motor vehicle (2) having two longitudinal profiles (4) extending forward from a passenger compartment of the motor vehicle; a front face crossmember (12), the front face crossmember (12) comprising means for temporarily supporting, during assembly, a structural crossmember (10) for connecting the two longitudinal profiles (4).

### CROSS-REFERENCE TO RELATED APPLICATIONS

This application is the US National Stage under 35 USC § 371 of International Application No. PCT/FR2022/050096, filed Jan. 18, 2022, which claims the priority of French application 2101550 filed on Feb. 18, 2021, the content (text, drawings and claims) of both said applications being incorporated by reference herein.

### BACKGROUND

The devices and methods disclosed herein relate to the field of motor vehicles, in particular to the field of motor vehicle structures and their capacity to successfully undergo crash tests, in particular for frontal impact.

There is a series of crash tests with standardized and recognized procedures, making it possible to evaluate motor vehicles as regards their passive safety. There are in particular crash tests specific to the American market, referred to as “driver-side small overlap front test” and “passenger-side small overlap front test”, developed by the “Insurance Institute for Highway Safety” (IIHS). The IIHS is an independent scientific and educational non-profit organization devoted to reducing loss due to death, injury and material damage from vehicle accidents. This test is designed to reproduce what happens when the front left corner of a vehicle collides with another vehicle or an object such as a tree or a post. This collision test is a challenge for certain safety belt and airbag designs, since the occupants move both forward and towards the side of the vehicle. In the driver-side small overlap front test, a vehicle moves at 64 km/h toward a rigid barrier 150 cm high. A mannequin representing a man of average size is placed in the driver's seat. Twenty-five percent of the total width of the vehicle strikes the barrier on the driver's side. Most modern cars have safety cages encapsulating the passenger compartment that are designed to resist frontal collisions and moderate overlap frontal collisions with little deformation. At the same time, the crush areas help to manage the collision energy in order to reduce the forces on the passenger compartment. The main structures of the crush zone are concentrated in the middle half of the front end. When an accident involves these structures, the passenger compartment is protected against intrusions and the front airbags and the safety belts can retain and protect the occupants effectively. Small-overlap frontal collisions mainly affect the exterior edges of a vehicle, which are not well protected by the structures of the crush zone. The collision forces go directly into the front wheel, the suspension system and the front panel. It is not rare for the wheel to be forced backward into the floor, contributing even more intrusion into the passenger compartment and leading to serious injuries to the legs and to the feet. To provide effective protection in small-overlap collisions, the safety cage must resist collision forces that are not moderated by the structures of the crush zone. To this end, it is known to provide a structural crossmember located at the front face and attached directly to the ends of the front beams. This crossmember is structural in that it has a certain rigidity and bulk, and consequently a significant weight, for example at least 10 kg. Such a bulk poses some problems of work ergonomics during its assembly.

The published patent document FR 3031 952 A1 discloses a front face module comprising a front face crossmember and two lateral uprights configured to be easily assembled with said front face crossmember, in this case by an insertion connection system. This front face module thus has a reduced volume in the non-assembled state and can be easily assembled while having sufficient rigidity. However, this face module is limited to supporting various elements such as the engine cooling radiator, the headlights and the front hood lock. It does not ensure a rigid connection between the two beams as the aforementioned structural crossmember does. This document therefore lacks a solution to the aforementioned problem.

### SUMMARY

The devices and methods described herein overcome at least one of the disadvantages of the aforementioned prior art. More specifically, the aim is to facilitate the mounting of a structural crossmember at the front of a motor vehicle, the crossmember in question being intended to be attached to the two longitudinal profiles or beams of the vehicle structure.

The description relates to a motor vehicle having two longitudinal profiles extending forward from a passenger compartment of the motor vehicle; a front face crossmember; notable in that the front face crossmember comprises means for temporarily supporting, during assembly, a structural crossmember for connecting the two longitudinal profiles.

According to an advantageous embodiment, the temporary support means comprise at least two hooks protruding forward.

According to an advantageous embodiment, the front face crossmember is made of plastic, the temporary support means being integrally formed with said front face crossmember.

According to an advantageous embodiment, the temporary support means are configured to support a central portion of the structural crossmember.

Advantageously, the central portion of the structural crossmember is transverse and rectilinear.

According to an advantageous embodiment, the motor vehicle comprises the structural crossmember, said structural crossmember having an inverted U-shape and comprising a central portion facing the front face of the front face crossmember, and two lateral portions extending downward from two ends of the central portion and attached to the two longitudinal profiles, respectively.

According to an advantageous embodiment, each of the two lateral portions of the structural crossmember comprises a plate attached by screwing to a plate of the corresponding longitudinal profile.

According to an advantageous embodiment, each of the two lateral portions forms a hollow body with a cross-section decreasing toward the central portion of the structural crossmember.

According to an advantageous embodiment, the at least two hooks are configured to extend under and in front of the central portion of the structural crossmember or to be inserted into openings formed in a lower face of said central portion.

The described devices and methods also relate to a front face crossmember for a motor vehicle, comprising a main longitudinal portion with two opposite ends; means for fastening at the opposite ends of the main longitudinal portion; notable in that the front face crossmember further comprises at least two hooks on a front face of the main longitudinal portion.

The features stated in relation to the motor vehicle apply to the front face crossmember and vice versa.

The at least two hooks advantageously form a support direction parallel to the direction of the main longitudinal portion. The at least two hooks are advantageously configured to support a rectilinear portion of a structural crossmember. The at least two hooks are advantageously configured to support a total load of at least 10 kg.

The described devices and methods also relate also relates to a method for assembling a motor vehicle, comprising the following steps: (a) mounting a front face crossmember, (b) mounting a structural crossmember at the front of the front face crossmember, and step (b) comprises temporarily positioning the structural crossmember onto the temporary support means of the front face crossmember, and then fastening the structural crossmember to the two longitudinal profiles.

The described measures are advantageous in that they facilitate the mounting of the structural crossmember, ensuring a temporary support in the mounting position. The mounting of the structural crossmember is in fact subsequent, temporally, to the mounting of the front face crossmember, meaning that the latter is present at the time of assembly of the structural crossmember. Also, the structural crossmember is positioned at the front of the front face crossmember. The devices and method described thus take advantage of the front face crossmember to facilitate the mounting of a potentially heavy part and which, moreover, cannot be placed on any neighboring support surface, in addition to the temporary support means. The positioning of the lateral portions of the structural crossmember opposite the front ends of the longitudinal profiles requires precise positioning in a transverse vertical plane, that is along the y- and z-axes in an orthonormal reference frame where the x-axis is a longitudinal axis, the y-axis is a horizontal transverse axis and the z-axis is a vertical axis, then the positioning along the x-axis can be finalized during the fastening, for example during the fastening of deformable chambers (“crashboxes”) in the forward extension of the longitudinal profiles.

### BRIEF DESCRIPTION OF THE FIGURES

FIG. 1 is a perspective representation of the front part of the structure of a motor vehicle.

FIG. 2 is a detailed view of the front face of the motor vehicle of FIG. 1.

FIG. 3 shows a front face crossmember making it possible to temporarily support, during the mounting, the structural crossmember, according to a first embodiment.

FIG. 4 shows a front face crossmember making it possible to temporarily support, during the mounting, the structural crossmember, according to a second embodiment.

### DETAILED DESCRIPTION

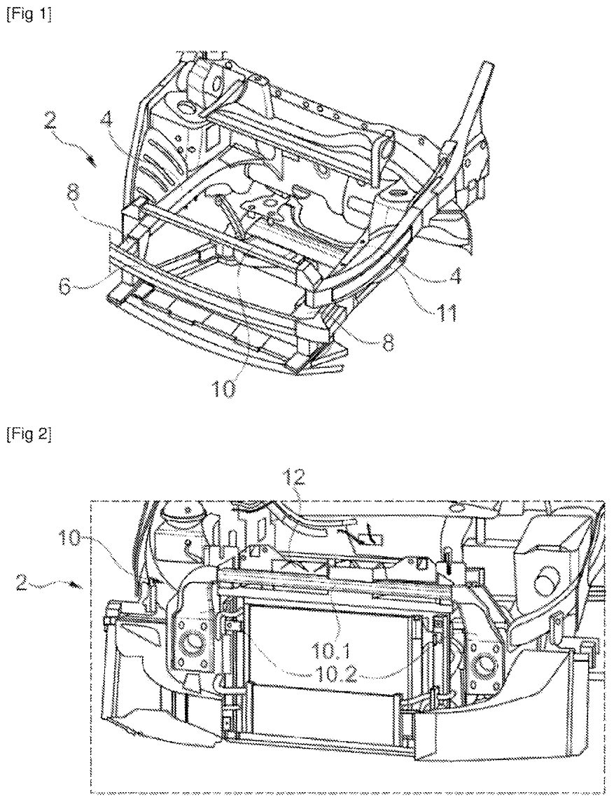

FIG. 1 shows the front pitch of a motor vehicle structure.

The motor vehicle 2 has, at the front, two longitudinal profiles 4 extending forward from the passenger compartment of the motor vehicle, under the floor of said vehicle, these longitudinal profiles commonly being referred to as beams, by analogy with the poles of a stretcher. A front bumper crossmember 6 is attached at the front ends of the longitudinal profiles 4 via two deformable compression chambers 8, commonly referred to as crashboxes.

The motor vehicle 2 has the particularity of comprising a structural crossmember 10 mechanically connecting the ends of the two longitudinal profiles 4. The structural crossmember 10 has a generally inverted U-shape, with a central portion forming a transverse profile and two lateral portions rigidly connected to the central portion and attached to the ends of the two longitudinal profiles 4. Each of the two lateral portions may form a hollow body with a cross-section that decreases toward the central portion. This crossmember is structural in that it is solid and provides substantial reinforcement of the structure of the motor vehicle. This reinforcement is intended to make the motor vehicle compatible with the small-overlap crash test developed for the American market and mentioned above in the “Prior art” section. In this crash test, the overlap between the obstacle and the front face of the vehicle is so small that the obstacle avoids the longitudinal profile or beam located on the side of the obstacle. It is therefore the bumper crossmember 8, the front wheel (not shown) and the front reinforcement 11 that will work to absorb the impact. To this end, the corresponding transverse profile 4 or beam tends to deform laterally toward the center of the vehicle. The structural crossmember 10 contains, or at least limits, this tendency and allows the motor vehicle to pass the aforementioned test.

FIG. 2 is a more detailed view of the front face of the motor vehicle of FIG. 1. In this view, the front bumper crossmember and the crashboxes shown in FIG. 1 are absent. The structural crossmember 10 is clearly visible therein, in particular the generally rectilinear and transverse central portion 10.1, and the two lateral portions 10.2 extending downwards from the ends of the central portion 10.1 and attached at the front ends of the two longitudinal profiles (not visible). FIG. 2 shows the presence of a front face crossmember 12 directly behind the structural crossmember 10. The front face crossmember 12 is attached at its ends to the wheel arch liners (not shown) and serves as a support, in particular to the radiator for cooling the internal combustion engine and/or to the heat exchanger of the air-conditioning system, to the front headlights and/or to the front hood lock, in a manner known per se.

The front face crossmember 12 is used to temporarily support the structural crossmember 10 when it is mounted on the motor vehicle. With reference to the description of the structural crossmember 10 in connection with FIG. 1, that crossmember 10 has a certain thickness, typically a weight of at least 10 kg. It is therefore particularly useful to be able to support it temporarily, in the mounting position. Temporary support means are provided on the front face crossmember 12, advantageously on the front face of the front face crossmember 12, designed to support the central portion 10.1 of the structural crossmember 10. The lateral portions 10.2 of the structural crossmember 10 can thus be attached at the front ends of the longitudinal profiles.

FIG. 2 shows that each of the lateral portions 10.2 comprises a plate attached against a plate (not visible) at the front end of the corresponding longitudinal profile, by means of fastening screws through the fastening orifices. Crashboxes, as shown in FIG. 1, can then be attached against the lateral portions 10.2 in the extension of the longitudinal profiles, in order to support the front bumper crossmember, as shown in FIG. 1.

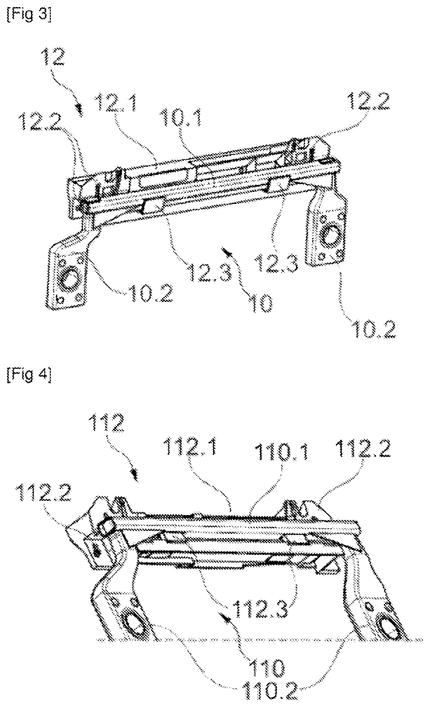

FIG. 3 illustrates a front face crossmember making it possible to temporarily support, during the mounting, the structural crossmember, according to a first embodiment.

The front face crossmember 12 comprises a main longitudinal portion 12.1 with two opposite ends, and fastening means 12.2 at the opposite ends in question. These fastening means 12.2 are in this case orifices provided to ensure attachment to the front wheel arch liners and the front wheel arches. The front face crossmember 12 further comprises two hooks 12.3 protruding forward and configured to support the structural crossmember 10. The two hooks 12.3 are advantageously implanted on the front face of the main longitudinal portion 12.1 of the front face crossmember 12. In this case, each of the two hooks 12.3 has an L-shaped longitudinal section, that is with a generally horizontal portion protruding forward from the front face crossmember 12 and supporting a lower face of the central portion 10.1 of the structural crossmember 10, and a generally vertical portion extending upward at the front of the central portion 10.1 of the structural crossmember 10.

FIG. 4 illustrates a front face crossmember making it possible to temporarily support, during the mounting, the structural crossmember, according to a second embodiment. The reference numbers from the first embodiment are used to designate the elements that are identical or corresponding to the second mode, these numbers however being increased by 100. Reference is also made to the description of these elements in the first embodiment.

The second embodiment differs from the first embodiment in that the hooks 112.3 do not extend substantially vertically in front of the central portion 110.1 of the structural crossmember 110 but in orifices made in said central portion 110.1. These orifices are made in a lower face of the central portion 110.1 of the structural crossmember 110.

This configuration of the temporary support means of the structural crossmember is advantageous in that these means, namely the hooks 112.3, do not extend at the front of the structural crossmember 110, in particular its central portion 110.1, so as not to interfere with the elements of the motor vehicle located at the front of the structural crossmember 110 and capable of moving toward the crossmember in question.

It can be seen that the structural crossmembers 10 and 110 illustrated in FIGS. 3 and 4 are somewhat different from what is shown in FIGS. 1 and 2. This does not however change anything to the described principle and further shows that the described devices and methods are compatible with different structural crossmember executions.

The two embodiments of the means for temporarily supporting, during assembly, the structural crossmember, described above, illustrate in a non-limiting manner, it being understood that other embodiments can be envisaged. By way of example, these temporary support means may comprise a single hook or even more than two hooks. They can also be removable, that is able to be removed after mounting the structural crossmember and/or installed specifically before mounting the structural crossmember.

In general, the front face crossmember can be made of plastic, by injection molding. To this end, the temporary support means are advantageously made of the same piece as the front face crossmember. However, they may alternatively be added to the front face crossmember.

1. A motor vehicle comprising:
two longitudinal profiles extending forward from a passenger compartment of the motor vehicle;
a front face crossmember;
wherein
the front face crossmember comprises means for temporarily supporting, during assembly, a structural crossmember intended to connect the two longitudinal profiles.

2. The motor vehicle according to claim 1, wherein the temporary support means comprise at least two hooks protruding forward.

3. The motor vehicle according to claim 1, wherein the front face crossmember is made of plastic, the temporary support means being integrally formed with said front face crossmember.

4. The motor vehicle according to claim 1, wherein the temporary support means are configured to support a central portion of the structural crossmember.

5. The motor vehicle according to claim 1, wherein the motor vehicle comprises the structural crossmember, said structural crossmember having an inverted U-shape and comprising:
a central portion opposite the front face crossmember;
two lateral portions extending downwards from two ends of the central portion and attached to the two longitudinal profiles, respectively.

6. The motor vehicle according to claim 5, wherein each of the two lateral portions of the structural crosspiece comprises a plate attached by screwing to a plate of the corresponding longitudinal profile.

7. The motor vehicle according to claim 5, wherein each of the two lateral portions forms a hollow body with a cross section decreasing toward the central portion of the structural crossmember.

8. The motor vehicle according to claim 5, wherein the temporary support means comprise at least two hooks protruding forward, further wherein the at least two hooks are configured to extend under and in front of the central portion of the structural crossmember or to be inserted into openings formed in a lower face of said central portion.

9. A front face crossmember for a motor vehicle, comprising:
a main longitudinal portion with two opposite ends;
fastening means at the opposite ends of the main longitudinal portion;
wherein the front face crossmember further comprises:
at least two hooks on a front face of the main longitudinal portion.

10. A method for assembling a motor vehicle, comprising the following steps:
(a) mounting a front face crossmember;
(b) mounting a structural crossmember in front of the front face crossmember;
wherein
the motor vehicle is according to claim 1; and step (b) comprises temporarily positioning of the structural crossmember on the temporary support means of the front face crossmember, and then fastening the structural crossmember to the two longitudinal profiles.
